(19) United States
(12) Patent Application Publication
(10) Pub. No.: US 2011/0298635 A1
(43) Pub. Date: Dec. 8, 2011

(54) SELF DYNAMO SMART FLOW UTILITY METER AND SYSTEM FOR FLOW UTILITY REAL-TIME FLOW USAGE MONITORING AND CONTROL, SELF ERROR AND LEAKAGES MONITORING

(76) Inventor: Bernie Yip, (US)

(21) Appl. No.: 13/153,237

(22) Filed: Jun. 3, 2011

Related U.S. Application Data
(60) Provisional application No. 61/351,813, filed on Jun. 4, 2010.

(51) Int. Cl. G08B 21/00

(52) U.S. Cl. 340/870.16

(57) ABSTRACT

A self dynamo smart flow utility meter providing self electric energy, real-time wireless data transmission ability and remotely flow control ability is disclosed. Also, a method and system for flow utility real-time flow usage monitoring and control, self error diagnostic and self leakage monitoring is disclosed.

### RELATED APPLICATIONS

The present application is a continuation application of U.S. provisional patent application, Ser. No. 61/351,813, filed Jun. 4, 2010, included by reference herein and for which benefit of the priority date is hereby claimed.

### FIELD OF THE INVENTION

This invention relates to a flow utility meter which provides self dynamo ability, real-time wireless data transmit ability and remote control abilities. Furthermore, the invention relates to a system and method provides real-time remote reading flow utility usage ability, self error diagnostic ability, self leakage detection ability and automatically remote control self dynamo smart flow meter within its network.

### BACKGROUND OF THE INVENTION

Traditionally, utility company has to employ “meter readers” to visit each customer location or home and take the reading, by visually observing the meter and recording in tabulated form a hand-written record of the utility consumption and the corresponding customer. Such a method is very time consuming and, thus, costly. Additionally, there is a chance workers may incorrectly read one or more meters thereby providing incorrect data to utility company. Also, current utilities flow meter only has one communication; they could not receive remote commands.

1. The improved method was disclosed from master meter call “Connection-Free RF Drive-By System”. It requires a driver drive by each single utility water meter and the recording device record wirelessly the meter usage. Those utility meter powered by an internal battery with a service life of up to 10 years since they only to activate once a while like every month.

2. Using RF signals to transmit data from a remote to a central location is well known in the prior art. Further, the use of RF signals to transmit utility meter data is also well known. For instance, U.S. Pat. No 3,688,271 discloses a method and apparatus for transmitting utility meter data from a single consumer meter to a mobile command unit utilizing RF signals. U.S. Pat. No. 5,448,230 and U.S. Pat. No 6,351,233 attempts to provide an enhanced automatic system for reading data from utility meter and sending it to central location. However, they all could NOT provide REAL-TIME flow usage data, self error diagnostic, self leakage detection and remote flow rate control capabilities.

3. An oracle white paper, “Smart Metering for Water Utilities” Oracle claims “Interval meters on customer premises that measure consumption during specific time periods and communicate it to the utility, often on a daily basis. While in the electric industry, measurement intervals can be as short as every 10 or 15 minutes, water intervals of 30 to 60 minutes or longer generally provide adequate information”. However, the system could not provide self error detection ability. If one of more water meters report wrong data, it affects the information accuracy. Also, the oracle white paper did not mention how they could solve the power issues.

4. Some cities in U.S. disclosed water automated meter reading (AMR) project. AMR wirelessly reads customer meters and then transfers the data into a secure billing system. However, AMR only provide reading ability. Also, it could not remotely control each AMR meter in read time. Furthermore, the lifetime of the AMR meter could only last for about 15 years.

### SUMMARY OF THE INVENTION

The invention solves all the problems discussed above regarding the prior art.

The invention provides a self dynamo smart flow meter not only reads and stores the flow utility usage and flow pressure data, but it also reports the flow rate/usage in real-time wirelessly. Also, it provides self electric energy and flow control abilities. Since the invention could generate sufficient electric energy for itself, the invention solves the power issue of the flow utility meter. In addition, the invention includes a microcontroller and wireless transceiver. Therefore, the invention could report its flow usage in real-time wirelessly, and it could also provide remote control abilities.

Furthermore, this invention develops new self dynamo unit special for flow utility meter shown in FIG. 3. This invention let the flow utilities flow in and flow out the Self Dynamo Smart Flow Meter much smoother and it increases the efficiency of the energy transformation compared to other dynamo unit in other flow generators.

Once the flow utilities flows through self dynamo smart flow utility meter as shown in FIG. 1, the self dynamo smart flow utility meter generates electric energy by its magnet and coil of conductive wire based on Faraday theory by the flow force. Also, the flow movement activates the microcontroller and wireless unit that are in the meter. The microcontroller senses and records the flow usage with the flow count sensor module and pressure data with its pressure sensor. Also, the microcontroller packages and encrypts flow usage data, and then it wirelessly transmits data to its parent meter, repeater or central server. In the meantime, the meter also is in receiving mode to see if any wireless command from its central server or its parent meter to control its flow rate or change its setting as shown in the flow chart FIG. 7 and FIG. 8.

Furthermore, the invention provides a method and system supporting real-time flow utility usage monitoring, self error detection and flow leakage diction.

One or more Self Dynamo Smart Flow Utility meters are deployed as a tree network as shown in FIG. 5. The flow utilities flow through the meter tree network to the end user. The central server receives all the flow usage data from its tree network as shown in FIG. 6. The parent meter receives all flow rate from its children meters, then it compares the flow rate/usage which it sensed and the total flow rate/usage which reported by its children meters as shown in FIG. 8. Therefore, the parent meter 608 or central server 601 could detect if any leakage or meter error under its tree network. Once the parent meter 608 or central server 601 detected an error, it will send out an alert to the central server 601 by the wireless network. Therefore, the system manager could fix the flow leakage or meter immediately. For example, the parent meter 608 or the central server 601 senses the real-time flow rate is 100 gallons per second. Also, the system allows +/−2% error. The children meters 631 under the parent meters 608 or central server 601 report total 98 gallons per second. The parent meter 608 and its tree network is healthy. However, if the children meters 631 under the parent meters 608 report total 105 gallons per second. The parent meter 608 or central server 601 generates an alert to the central server.

Depends on the network situation, if the child meter 607 is far away from its parent meter 621, or the meters is far away from the central server, the network could includes one or more meters 620 as repeaters or third party wireless repeater 605. Also, an external transceiver could connect to each individual self dynamo smart flow utility meter for better wireless signal. Also, the power of the external transceiver could be provided by the self dynamo smart flow utility meter which is connected to it.

As mention above, the central server could receive all flow usage data in its network real-time. Therefore, all flow usage data could record into its database. The invention includes a web based user interface. End users could register their daily regular flow usage and their personal information such as phone number and email address into the database. The central server could compare their registered daily information and the real-time usage level. If the real-time usage level shows a dangerous level, the central server sends out an alert to the end user with internet or cell phone network. For example, an end user registered 1 gallon water or gas use from 2 p.m. to 3 p.m. on daily usage, but the central server receives 10 gallons water or gas usage from 2 p.m. to 3 p.m. from the registered self dynamo smart flow utility meter, the central server sends out an alert to the end user by email 602 or test message. Furthermore, the end user could require the control server to shutdown the flow usage remotely through mobile phone communication interface or web interface. Therefore, the system could reduce the chance of accident happens as well.

### BRIEF DESCRIPTION OF THE DRAWINGS

A complete understanding of the present invention may be obtained by reference to the accompanying drawings, when considered in conjunction with the subsequent, detailed description, in which:

FIG. 1 illustrates an example a front view of a self dynamo smart flow utility meter;

FIG. 2 illustrates a cross section side view of a self dynamo smart flow utility meter;

FIG. 3 illustrates a cross section top view and a cross section side view of the dynamo portion which is in a self dynamo smart flow utility meter;

FIG. 4 illustrates a simplified block diagram of components and modules in a self dynamo smart flow utility meter;

FIG. 5 illustrates a diagram of self dynamo smart flow utility meters being deployed in a flow utilities tree network;

FIG. 6 illustrates a flow utility real-time flow usage monitoring and control, self error and leakages monitoring system communication network. It shows the wireless data communicated network among self dynamo smart flow utility meters, central server and repeater. Also, it shows the communication interfaces between the central server and end users;

FIG. 7 illustrates a detail state diagram for the algorithm implemented in the firmware in the lowest tier self dynamo smart flow utility meter;

FIG. 8 illustrates a detail state diagram for the algorithm implemented in the parent self dynamo smart flow meter and central server;

FIG. 9 illustrates communication links and direction among self dynamo smart flow utility meters, repeater and central server;

FIG. 10 illustrates a simplified block diagram of the central server for the system of this invention; and

FIG. 11 illustrates a detail state diagram of lower power sensing mode algorithm in the self dynamo smart flow utility meter.

For purposes of clarity and brevity, like elements and components will bear the same designations and numbering throughout the Figures.

### DESCRIPTION OF THE PREFERRED EMBODIMENT

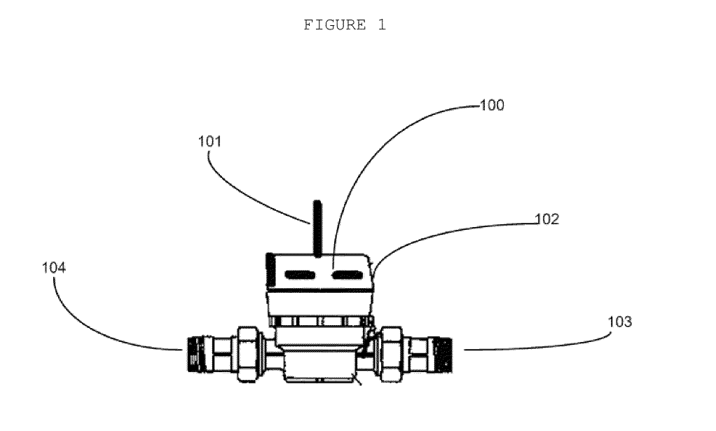

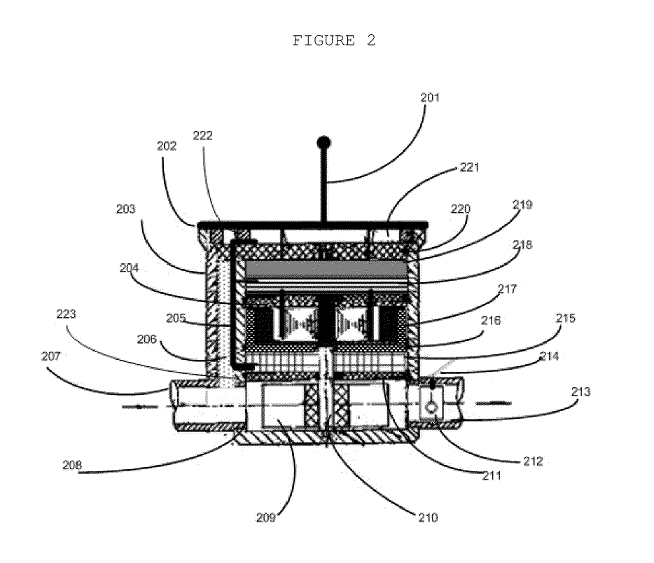

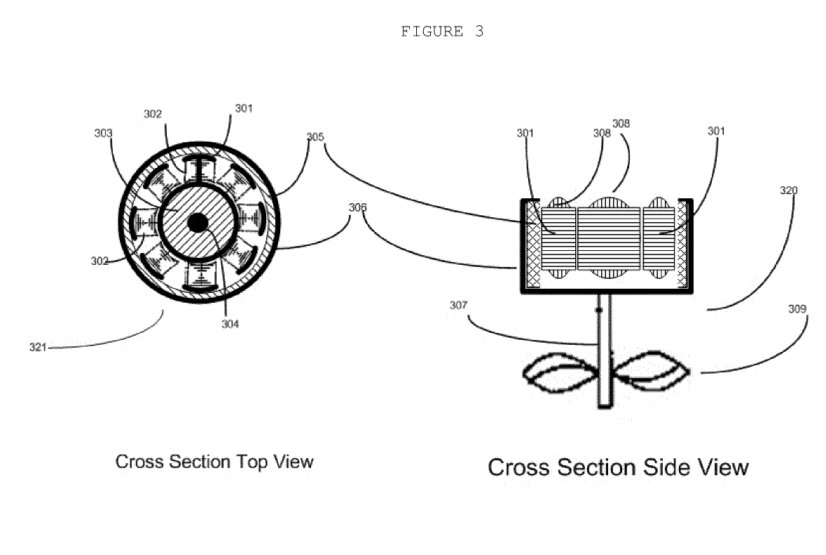

A front view of a self dynamo smart flow utility meter is shown in FIG. 1. The description and operation of the self dynamo smart flow meter invention will be best initiated with reference to FIG. 2. Most of self dynamo smart flow meter components are inside of the external housing chamber 203. The antenna 201 is physically connected to a cover 202 and the antenna 201 wire is connected to the smart electric circuit 218. On the top of the smart electric circuit 218 is the electric energy storage, battery 219, on the top of battery 219, is the thermal baffle plate 220 which isolates the display 221 and rest of the components under it. The electric energy storage unit 219 is right under the thermal baffle plate 220. The display power input and control signal is connected to the smart electric circuit 218 through the signal tunnel 205. The display only will be activated when the cover 202 open by released the on/off switches 222. Under the smart electric circuit 218, is other baffle plate 204 which is a grounded baffle plate and connects to the ground signal of the smart electric circuit. Also, the baffle plate 204 connects to the coil holding frame 301 supporting connection 304 of the dynamo module 217. Furthermore, there is a small hole on the edge of the baffle plate 204 which allow the dynamo module power wire connects to the smart electric circuit. Under the baffle plate 204 is the dynamo module 217. The detail drawing of dynamo module 217 is shown in FIG. 3. The magnet housing 216 is on the bottom of the dynamo module 217, magnet housing 216 connects to impeller axis 210; therefore, it will follow the impeller wheel 209 to spin. Under the magnet housing 216 is the flow count sensor module 215 which sense the flow movement. The power input and flow count signal wires of the flow count sensor module 215 connects to the smart electric circuit 218 through the signal tunnel 205. Under the flow count sensor module is another baffle plate 211 which isolate the water which goes through the impeller chamber 208 to all others components above the baffle plate 211. Inside of the impeller chamber 208 is the impeller wheel 209. The impeller axis 210 goes through the baffle plate 211 and the flow count sensing module, and connects to the magnet housing 216. In between the baffle plate 223 and the external housing chamber 203 is a pressure sensor 206 which senses the flow pressure and is connected to the smart sensing circuit 218 through the signal tunnel 205. There is a flow control switches 212 which could be controlled by the smart electric circuit 218 or the manual switches 214 on the flow output side connection 213. It could stop or allow flow utility flow out from the self dynamo smart flow utility meter 100.

The description and operation of the dynamo module of self dynamo smart flow utility meter 100 will be best initiated with reference to FIG. 3. As shown on the side view 320, the impeller wheel 309 connects to the magnet housing 306 through impeller axis 307. Also, the cylinder magnet 305 is attached to the magnet housing 306. Therefore, the cylinder magnet is span by the impeller wheel 309 through flow movement pass through the impeller chamber 208. The coil of conductor wire 308 and the coil supporting frame 301 are mounted on the fixed copper axis 303 which connects to the baffle plate 204. Therefore, the coil of conductor wire 301 is mounted is a fixed location.

Self dynamo smart flow utility meter 100 apply Faraday theory generates the electric energy by the flow utility such as water flow and gas flow. Once the flow utility flows through the self dynamo smart flow meter 100, the flow will move the impeller wheel 209 which span the axis 210; and the axis 210 is connected to magnet housing 306; therefore, it spin the cylinder magnet 305 which connects to the axis 307. Through the whole movement, it change the magnetic field pass through those fixed coils of conductive wire 302. Consequently, the whole process generates electric energy for the self dynamo smart flow utility meter operation and the extra electric energy is stored in the battery 219.

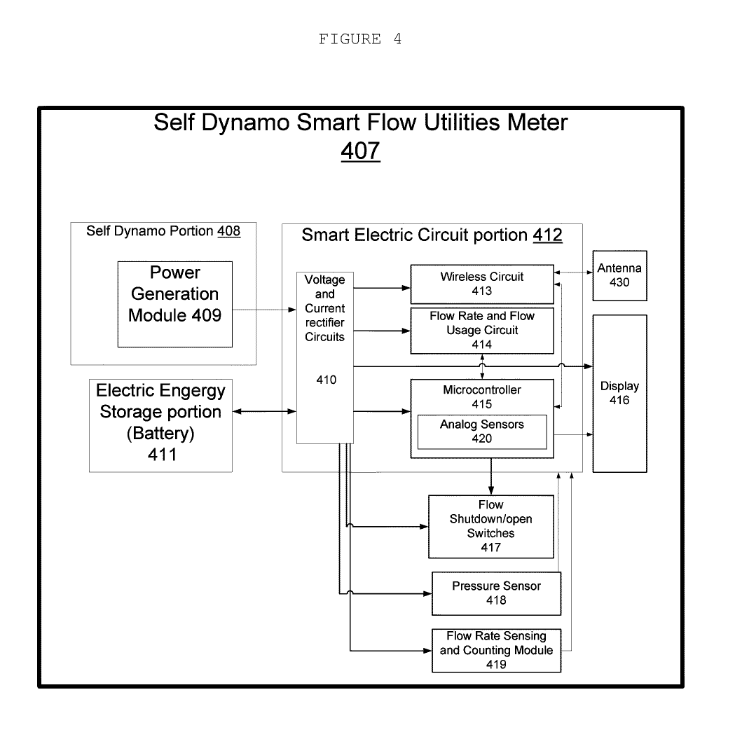

The self dynamo smart flow meter could be divided into different potions; they are self dynamo potion 217, flow control switches 417, pressure sensor 418, flow rate sensing and counting module 419, electric energy storage portion 411, antenna 430 and smart electric circuit portion 418 as shown in FIG. 4.

Which

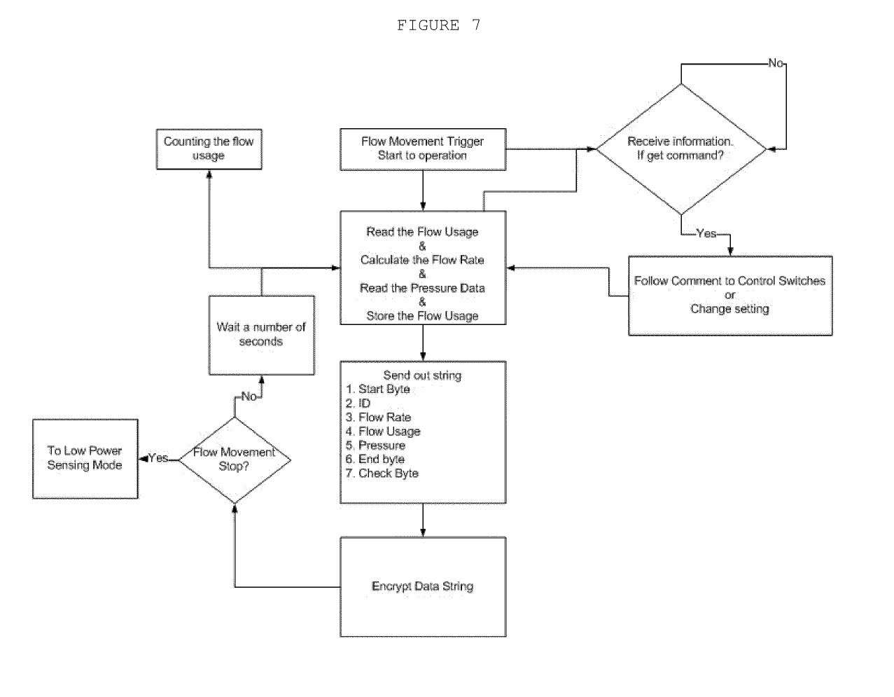

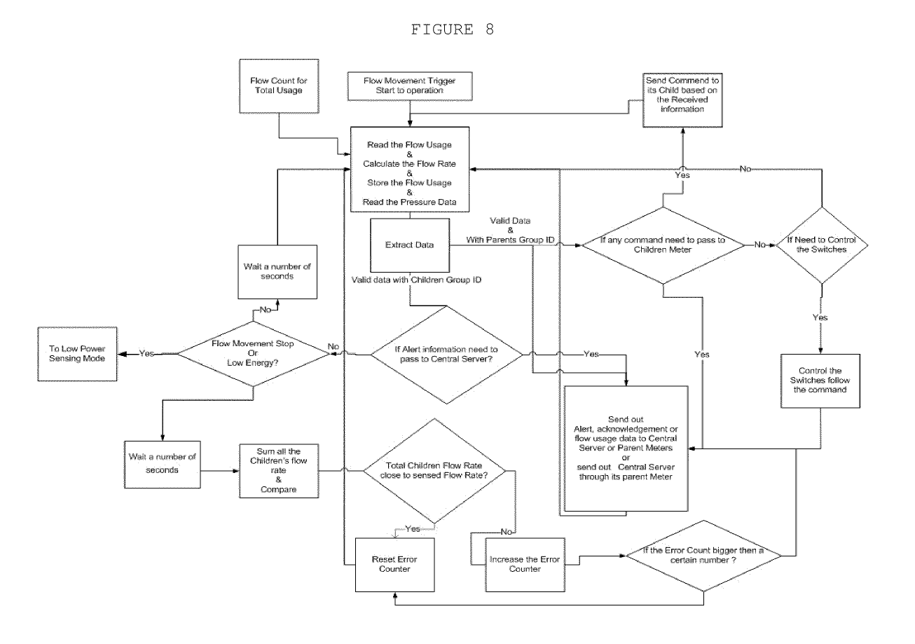

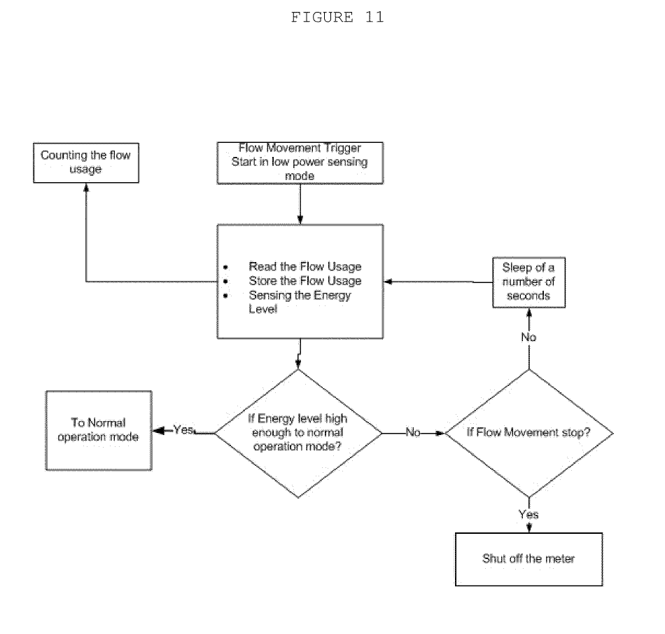

a. Smart electric circuit portion 418 includes
i. wireless circuit 413 transmitting data out from and receiving wireless information to the microcontroller 415
ii. flow rate and usage sensing circuit 414 counting and storing the flow usage data from the flow rate sensing and counting module 419
iii. The microcontroller 415 operates two different modes. One is lower power sensing mode as shown in FIG. 11, and normal operation modes are as shown in FIG. 7 and FIG. 8. Its operations are triggered by the impeller wheel 209, once the impeller wheel 209 spin, the microcontroller 415 start to sense the flow rate, and then send out information and receive the data from its parent meter 908, children meter 906, repeater 902 or central server 905 in the wireless network. Furthermore, the microcontroller comes with analog sensors 420; it could sense the energy level of the electric energy storage 411.
iv. Voltage and current rectifier circuit 410 rectifies the power from self dynamo unit 409 to electric energy storage 411. Also, it rectifies the power from the dynamo unit 409 and electric energy storage 411 to the rest of self dynamo smart flow utility meter electric components
   b. Self dynamo potion 408 includes power generation portion 409 which shown in FIG. 3. It generates electric energy, then the power is rectified by the voltage and current rectifier portion 410 such as a rectifier circuit; therefore, it could store the electric energy into the electric energy storage portion 411 such as rechargeable battery and provides the electric energy to the smart electric circuit portion 412, flow control switches 418, pressure sensor 418 and flow rate sensing and counting module 419.
c. The flow rate sensing and counting module 419 also connects to microcontroller 415 which records the flow usage and calculates the flow rate. Therefore, it sends out the flow rate and flow usage data wirelessly.
d. The output analog or digital signal of the pressure sensor 418 also connects to the microcontroller 415 which records the pressure data.
e. The control signal of utilities flow control switches 417 are connected to the microcontroller 415. Microcontroller could shutdown the switches 417 according to remote command; therefore, the invention could control individual flow utilities usage remotely.
f. Display 416 displays the heath information of the meter 100, flow usage and flow rate data. It is activated by a on/off switches 222

This invention provides a self dynamo smart flow utilities meter which also is a smart low power device. It operates in two modes. They are lower power sensing mode as shown in FIG. 11, and normal operation mode are as shown in FIG. 7 and FIG. 8. As shown in FIG. 11, self dynamo smart flow utilities meter low power sensing mode is triggered by the flow movement. Only the flow rate sensing and counting module 419 and the microcontroller 415 are powered in lower power sensing mode. Also, the microcontroller 415 operates in very low power. Its calculation speed less or equal to 32 Khz and lower then 1 mA current consumption. Once the microcontroller 415 sense the energy level is high enough to normal operation mode means fully functional. The self dynamo smart flow utilities meter fully power up and it operates as shown in FIG. 7 and FIG. 8. Also, the calculation speed of the microcontroller 415 is increased to its normal speed.

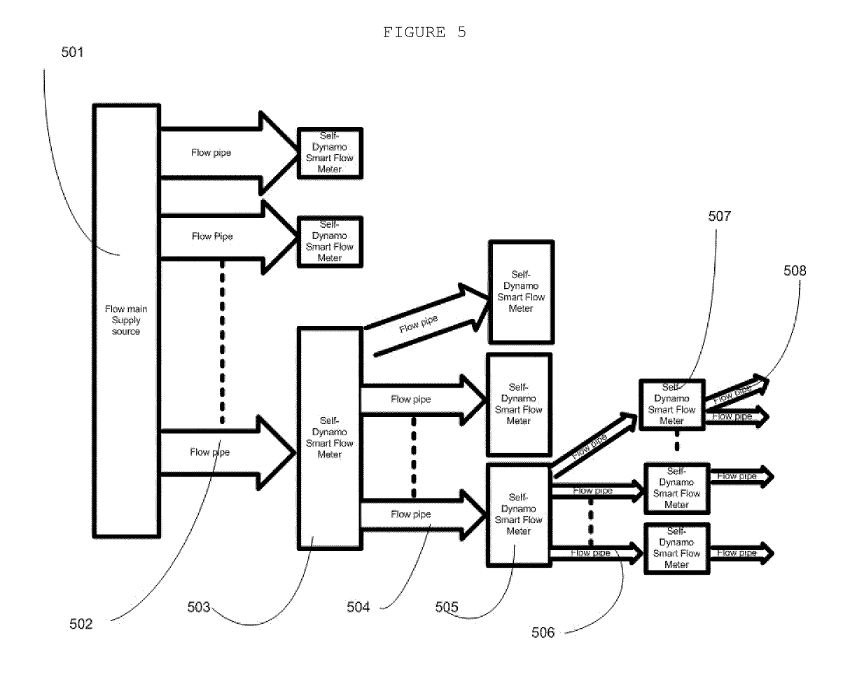

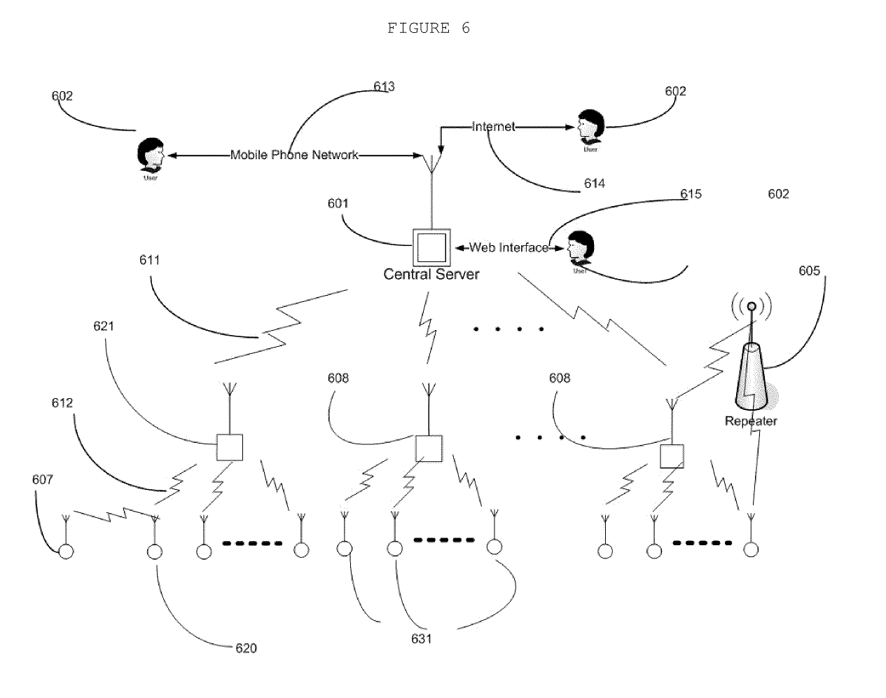

The description and operation of the system for flow utility real-time flow usage monitoring and control, self error and leakages monitoring is initiated with reference FIG. 6 and FIG. 5. One or more self dynamo smart flow meters are deployed on the field as a tree network shown in FIG. 5. The main flow supply source supply flows to its parent self dynamo smart flow meters 503 through flow pipes 502; and flow goes to the self dynamo smart flow meters 505 has to go through their parent self dynamo smart flow meter 503; the flow goes to the self dynamo smart flow meter 507 has to goes to the parent meter 505 and grand parent meters 503 of the self dynamo smart flow meter 507.

The parent flow pipes 506 let the flow utility flows to children meters 507 and each parent flow pipe connect with a self dynamo smart flow meter 505. Once the flow utility flows through one of the child meter 507, the flow utility has to flow though its parent meter 505 and event its grandparent meter 503. Therefore, the utility flow activates all meters in its path, which guaranties parent meters is powered and it could receive children meters data. The algorithm in FIG. 7 is implemented in the lowest level children meters and the algorithm in FIG. 8 is implemented in all parent meters 608 and central server 601. Once the total children meters' flow usage is not match with their parent meter's flow usage with a number of tolerances, an meter error or leakage is detected. Therefore, the whole system could detect the leakage or error. Also, all flow usage data could be sent out to the central server 601 and is saved in the databases 1051.

One or more self Dynamo smart flow meters are deployed on the tree wireless network as shown in FIG. 6. The communication between users 602 and central server 601 could be internet communication 614 or mobile phone network communication 613. Therefore, the central server 601 could email, text message or voice call to users 602, once it detects a leak or error. Furthermore, users 602 could register their personal information to database 1051 in the central server 601. Furthermore, end users 602 could register their daily regular flow usage and their personal information such as phone number and email address into central server 601. The central server 601 could compare their registered daily information and the real-time usage level. If the real-time usage level shows a dangerous level, the central server sends out an alert to the end user through its internet interface 614 or cell phone network interface 613. Furthermore, the end user could pre-set meter remote control action in the central server 601; for example, it shutdown the flow switches when an abnormal situation happen. Therefore, the central server 601 shutdowns the flow usage remotely, once it detects an abnormal situation. Therefore, the system could reduce accident happen.

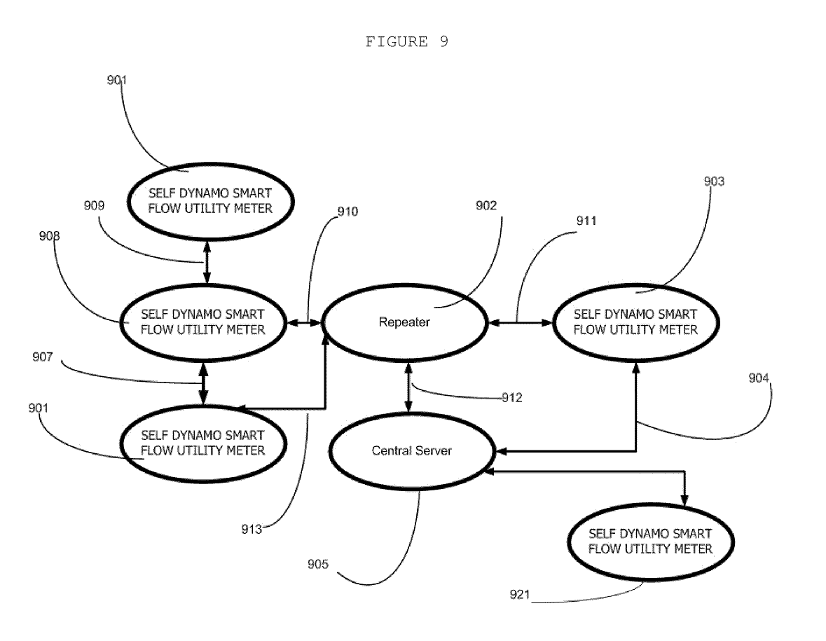

The best description of the communication link among self dynamo smart flow utility meters, repeater 902 and central server 905 is shown in FIG. 9. The self dynamo smart flow utility meters 903 could communicate with the central server directly or bridging by the repeater 902. If self dynamo self dynamo smart flow utility meters 921 is close enough to the central server, it could communicate with central server 905 directly. Furthermore, the children self dynamo smart flow utility meters 901 not only could send out their data to their parent self dynamo smart flow utility meter 908, it also could communicate with central server through their parent self dynamo smart flow utility meter 908.

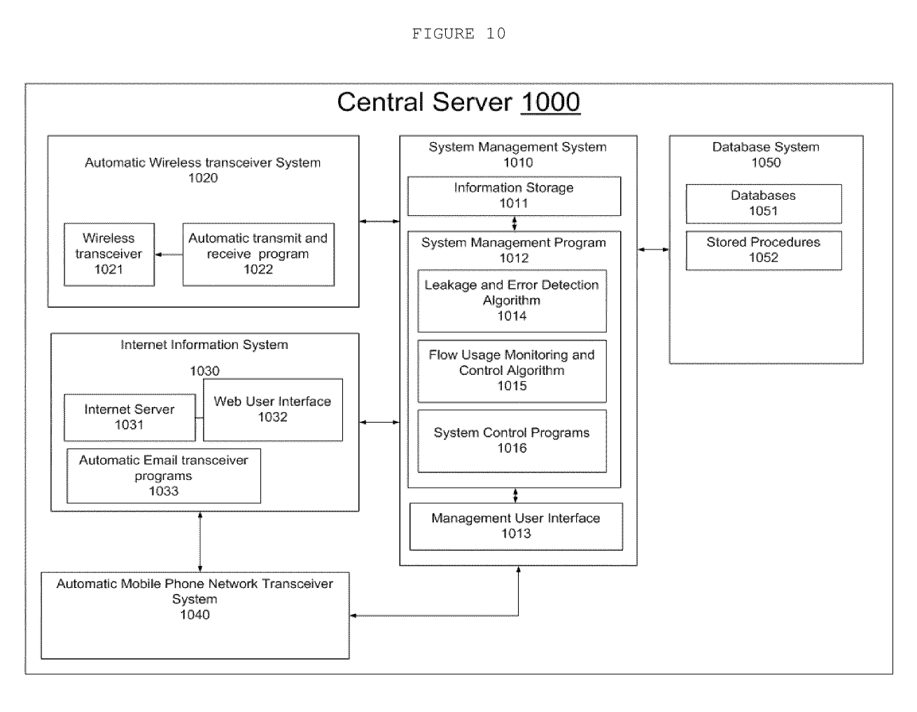

The description and operation of central server 1000 for this invention is shown in FIG. 10. The central server 1000 does not only providing flow utility network real-time flow usage monitoring and control, flow utility pipe network leakage and error monitoring; it also provides central data handling abilities. The central server 1000 gets all flow usage data from its automatic wireless transceiver system 1020. The automatic transmit and receive program 1022 delivers the flow usage information to the system management system 1010 once it receive flow data through its wireless transceiver 1021. Also, it transmits data to self dynamo smart flow utility meters from system management system 1010. System management program 1012 will be based on the setting information which saved in the information storage 1011 in the System management system 1010 save the data to database system. Also, the system management program 1012 and the developed stored procedures 1052 will calculate to determine if any abnormal situation such as leakage, error or abnormal usage occurs. Once the abnormal situation detected, it will generate an alert in the management user interface 1013; also, it will notice the end user by email through the internet information system 1030, or voice call or text message through automatic mobile phone network transceiver system 1040.

Moreover, the management users could control the whole system through the system management user interface. Also, the end users could register their personal information through the web user interface 1032 through the internet server 1031, and the web user interface will save their information into the databases 1051.

Having thus described the invention, what is desired to be protected by Letters Patent is presented in the subsequently appended claims.

What is claimed is:

1. A self dynamo smart flow utility meter and system for flow utility real-time flow usage monitoring and control, self error and leakages monitoring for new patent, comprising:
means for sensing and reporting the flow utility usage in real-time;
means for detecting and reporting the leakage and flow network error in the flow pipe network in read-time means for users could remotely shutdown said self dynamo smart flow utility meter in real-time;
means for remotely shutting down said self dynamo smart flow utility meter automatically;
means for end user could getting their real-time flow usage and leakage alert through the internet and cell phone network; and
means for central data handling and user data handling.

2. A new attribute 1 self dynamo smart flow utility meter with claim 1, comprising:
a new attribute 2 self dynamo unit, for generating electric energy for itself;
an electric energy storage, for storing the electric energy for itself;
a voltage and current rectifier circuit, for rectifying electric voltage and current to said electric energy storage and other electric components in the meter;
a wireless circuit, for transmitting/receiving flow usage, data and commands to/from other said self dynamo smart flow utility meters, repeater, or central server;
a flow rate and flow usage circuit, for counting, storing flow rate and flow usage data;
a flow shutdown/open switches, for controlling the flow usage;
a pressure sensor, for sensing the flow pressure in the flow pipe;
a flow rate sensing and counting module, for sensing and counting the flow usage;
a display, for displaying the status of the said meter;
a microcontroller, for implementing the low power sensing wireless sensing algorithm, self error and leakage monitoring algorithm and said remotely control algorithm; calculating and store flow rate and flow usage; sensing the said electric energy storage energy level; getting the flow pressure data; controlling said flow control switches; delivering/getting wireless data from said wireless circuit; and controlling the said display;
a lower power sensing mode algorithm for guarantying each individual said self dynamo smart flow utility meter has enough energy for its operations;
an operation algorithm in the lowest tier said self dynamo smart flow utility meter for reporting the flow usage in real-time;
a real-time flow usage monitoring and control, self error and leakages monitoring algorithm for real-time flow usage monitoring and control, self error and leakages monitoring;

3. The self dynamo smart flow utility meter and system for flow utility real-time flow usage monitoring and control, self error and leakages monitoring in accordance with claim 2, wherein said means for self generating electric energy comprises a new attribute 3 self dynamo unit, comprising:
a coil holding frame, for holding coils of conductive wires in a fixed location;
a said coil of conductive wire and a cylinder magnet generating electric energy by the spin movement of a impeller wheel;
a magnet housing, for protecting, holding the wherein said cylinder magnet; and connecting the cylinder magnet to a said impeller wheel;
a copper axis, for providing the fixed connection from the said coil holding frame to other fixed location components, so the said coil of conductive wire could be mounted in a fixed location; and
a said impeller wheel, for flow usage sensing and spinning the said cylinder magnet by the utility flow movement;

4. A system for flow utility real-time flow usage monitoring and control, self error and leakages monitoring in accordance with claim 1, comprising:
a lower power sensing mode algorithm for guarantying each individual said self dynamo smart flow utility meter has enough energy for operations;
an operation algorithm in the lowest tier said self dynamo smart flow utility meter for reporting the flow usage in real-time;
a real-time flow usage monitoring and control, self error and leakages monitoring algorithm in parent self dynamo smart flow utility meter and central server for real-time flow usage monitoring and control, self error and leakages monitoring;
a said self dynamo smart flow utility meter for sensing flow movement, reporting flow usage, providing remote control flow abilities, providing leakage and error abilities, and flow pressure sensing ability;
a flow pipe tree network, for providing flow to said self dynamo smart flow utility meters in the network;
a wireless network, for providing wireless communication channel among said central server, said self dynamo smart flow utility meters and said repeater;
a repeater, for bridging wireless data among said self dynamo smart flow utility meters; and between central server and said self dynamo smart flow utility meter;
a said central server, for providing central data handling and user interfaces;

5. Wherein said central server in claim 4 for providing central data handling and user interfaces, which comprises:
a said automatic wireless transceiver system, for transmitting and receiving wireless data
a system management system, for managing data
a database system, for handling all flow usage data and user data
a management user interface, for providing interface of system management ability to system manager
an Internet server, for providing Internet interface to users and communication between users and the said system for flow utility real-time flow usage monitoring and control, self error and leakages monitoring.
an automatic mobile phone network transceiver for providing mobile phone interface to users and communication between users and the said system for flow utility real-time flow usage monitoring and control, self error and leakages monitoring.
